(19) United States
(12) Patent Application Publication
(10) Pub. No.: US 2012/0047230 A1
(43) Pub. Date: Feb. 23, 2012

(54) CLIENT-INITIATED MANAGEMENT CONTROLS FOR STREAMING APPLICATIONS

(75) Inventors: Ali C. Begen, London (CA); Jayaraman R. Iyer, San Jose, CA (US)

(73) Assignee: CISCO TECHNOLOGY, INC., San Jose, CA (US)

(21) Appl. No.: 12/858,482

(22) Filed: Aug. 18, 2010

(51) Int. Cl. G06F 15/16

(52) U.S. Cl. 709/219

(57) ABSTRACT

A client device that is receiving streaming content on a connection from a streaming server over a network determines a need to suppress transmission of one or more packets from the streaming server on the connection over the network. The client device sends to the streaming server a message configured to cause the streaming server not to transmit the one or more packets to the client device for the connection without terminating the connection. The client device sends a further message that is configured to cause the streaming server to empty a buffer of packets that are queued for transmission but have not yet been transmitted (at a first bit rate) to the client device, so that the client device can send a request to the streaming server for transmissions of packets on the connection at a second bit rate.

### TECHNICAL FIELD

The present disclosure relates generally to streaming applications.

### BACKGROUND

Digital content is streamed over networks to deliver the content to a client device that may reside remotely from the streaming server. In order to maintain desired presentation of the content at the client device, the streaming server may have the same content encoded at multiple bit rates and the client device requests specific independently-decodable blocks of the content at a selected bit rate based on the available resources such as bandwidth, processing resources, time remaining to the deadline for the next block, etc. The streaming server and client device coordinate the delivery of the content using a protocol such as the Transmission Control Protocol (TCP) that is part of the Internet Protocol (IP) suite.

The streaming client uses the underlying TCP stack in its operating system and as a result all of the TCP rules apply. For example, according to TCP, the streaming server retransmits the missing packets even if the client device knows that it will not need them (because the packets are already late or will be late or the application has already received the same block of packets at a different quality). In these cases, the retransmissions are useless and waste the bandwidth that could be otherwise used by the other TCP connection(s) for the same or other streaming sessions.

Many of the current Hypertext Transfer Protocol (HTTP)-based adaptive client devices either send a TCP RESET (RST) message, or close the TCP connection, and reopen a new connection when something goes wrong with an existing TCP connection. The new connection has to start the entire TCP state machine again. This problem is amplified for slower or error-prone links such as wireless connections.

### BRIEF DESCRIPTION OF THE DRAWINGS

FIG. 1 is an example of a block diagram showing a streaming media environment comprising a streaming server and one or more client devices that are configured to send client-based connection management controls to the streaming server.

FIG. 2 is an example of a block diagram of a client device configured to generate and send client-based connection management controls to the streaming server.

FIG. 3 is an example of a flow chart for a client-based connection management control process executed in the client device to generate and send a pre-emptive acknowledgement message.

FIG. 4 is an example of a ladder flow diagram depicting an example in which the client device sends the pre-emptive acknowledgment message.

FIG. 5 is a diagram depicting an example of a scenario for use of the pre-emptive acknowledgment message that causes the streaming server to suppress transmission of one or more packets.

FIG. 6 is an example of a flow chart for a further operation of the client-based connection management control process in which the client device generates and sends a further message that is configured to cause the streaming server to flush its buffer.

FIG. 7 is an example of a ladder flow diagram depicting an example in which the client device sends the further message referred to in FIG. 6 to the streaming server.

FIG. 8 is a diagram depicting an example of a scenario for use of the further message configured to cause the streaming server to flush its buffer.

### DESCRIPTION OF EXAMPLE EMBODIMENTS

### Overview

Techniques are provided to enable a client device that is receiving streaming content from a streaming server to cause the streaming server to suppress or skip transmission of one or more packets on a connection to the client device. A client device that is receiving streaming content on a connection from the streaming server over a network determines a need to suppress transmission of one or more packets from the streaming server on the connection. The client device sends to the streaming server a message configured to cause the streaming server not to transmit the one or more packets to the client device for the connection without terminating the connection. Furthermore, the client device sends a further message that is configured to cause the streaming server to empty a buffer of packets that are queued for transmission but have not yet been transmitted (at a first bit rate) to the client device, so that the client device can send a request to the streaming server for a transmission of packets on the connection at a second bit rate. The techniques described herein are useful in connection with the TCP or any other now known or hereinafter developed protocol that may be similar to TCP in terms of requiring acknowledgment messages for guaranteed delivery of information.

### Example Embodiments

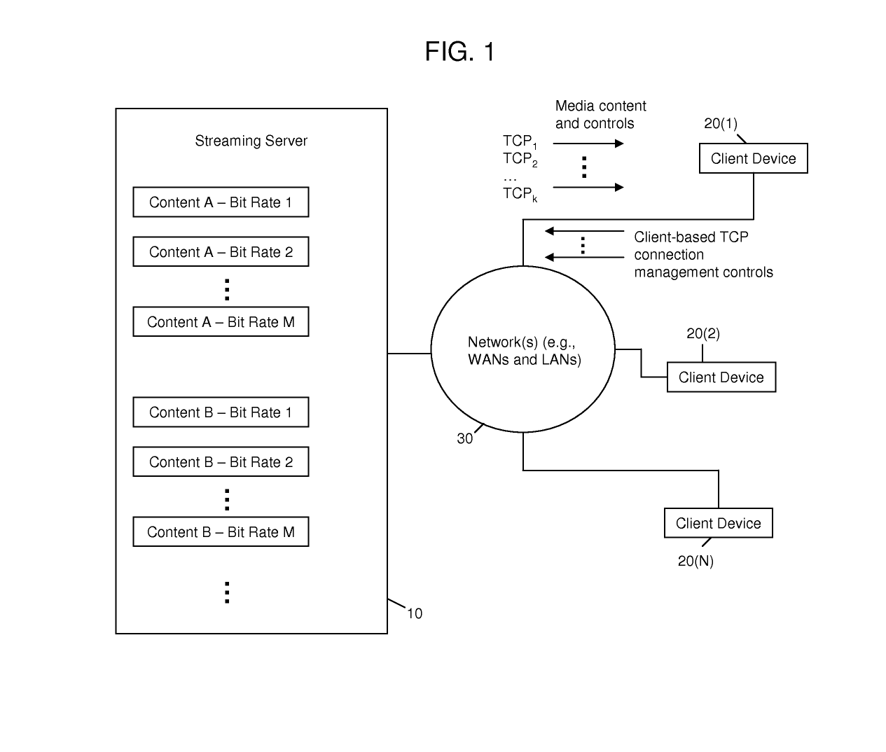

Referring first to FIG. 1, a block diagram is provided showing a streaming media environment comprising a streaming server 10 that is configured to stream digital media content to client devices shown at reference numerals 20(1)-20(N) over one or more networks shown at reference numeral 30. The network 30 may comprise one or more wide area networks (WANs) and one or more local area networks (LANs) including wired and wireless networks. The client devices may be personal computers (desktop or laptop), hand-held devices such as wireless telephones with wireless WAN or wireless LAN connectivity, etc.

The streaming server 10 stores digital media content to be streamed to the client devices. Examples of digital media content include video content (movies or other video productions), audio content (music or other audio productions), games, etc. In order to support adaptive streaming applications, the streaming server 10 stores data for a plurality of digital media content designated in FIG. 1 as “Content A”, “Content B”, etc. In addition, for each media program content, the streaming server stores different encoded bit rate versions or profiles, indicated as Bit Rate 1, . . . , Bit Rate M in FIG. 1. This allows the streaming server 10 to stream content to a given client device in any of a plurality of bit rate profiles and the client device can select the best bit rate profile to stream to it depending on network conditions while the content is being streamed. In other implementations, the streaming server 10 or other entities in the network may participate in the selection of the best bit rate profile.

One mechanism used when streaming digital media content is for the client device to request blocks or chunks of data (e.g., in 2 second intervals) from the streaming server continuously as the content is being streamed. A client device may request the content at a one bit rate profile which is relatively fast, and then determine, due to missed packets and the need to request for retransmissions of missed packets, that a second slower bit rate profile may be better. The network conditions may change over time and the client device can dynamically request to switch between different rate profiles for a streaming session as new blocks or “chunks” of data are requested. In so doing, the client device is trying to avoid a “freeze” condition where new data is available for its decoder in sufficient time to present the content without interruption or the appearance of discontinuities. This can be particularly important when delivery of the content is made over an error-prone link such as a wireless link.

Most client devices use the Hypertext Transfer Protocol (HTTP) for distributed, collaborative information exchanges. HTTP is a request-response standard for client-server computing. In HTTP, web browsers act as clients, while an application running on the computer hosting the web site acts as a server. HTTP uses the Transmission Control Protocol (TCP) that is part of the Internet Protocol (IP) suite of communications protocols used for the Internet and other similar networks.

During a streaming session using TCP, the streaming server 10 will try to retransmit all packets until they are acknowledged by the destination client device. In other words, the TCP requires all packets to be acknowledged as having been received before sending new packets that are queued and ready to be sent. Retransmitting packets to the client device uses available bandwidth in the networks that the packets travel to the client device. A so-called Head-of-Line (HOL) blocking problem occurs when new packets to be sent are blocked from transmission because the streaming server is retransmitting yet-to-be-acknowledged packets to the client device until the client device acknowledges those packets. This delays the transmission of the new packets to the client device that are queued up and ready to be sent by the streaming server. Adaptive streaming techniques have been developed to allow a client device to request the streaming server to establish different TCP connections to retrieve the same content at different bit rates, for a given media content and to request packets from a different TCP connection if one TCP connection becomes congested and starts performing poorly.

According to the techniques described herein, the client device, e.g., client device 20(1), is configured to send messages to the streaming server 10 to prevent HOL blocking and prevent overload on the network due to “old” transfers pending (i.e., unacknowledged packets) on a connection. From a network as well as client device perspective, the ability to drop packets that are to be retransmitted or new packets that are queued up at the sender (streaming server) for transmission to the client device can provide relief to bandwidth burdens in the network and also improve performance at the client device. The retransmitted packets are sent over the network and the access links, incurring additional cost both to the client as well as to the network.

Several approaches are provided herein, useful alone or in combination, to suppress transmission of packets and/or flush the server-side TCP buffers in connection with one or more TCP connections (identified as TCP₁, . . . , TCPₖ in FIG. 1) while maintaining the state of the TCP connection for further requests from the client device. The client device generates client-based (initiated) TCP connection management controls, as indicated in FIG. 1, to execute these techniques. The streaming server 10 responds with appropriate media content and controls for the one or more TCP connections.

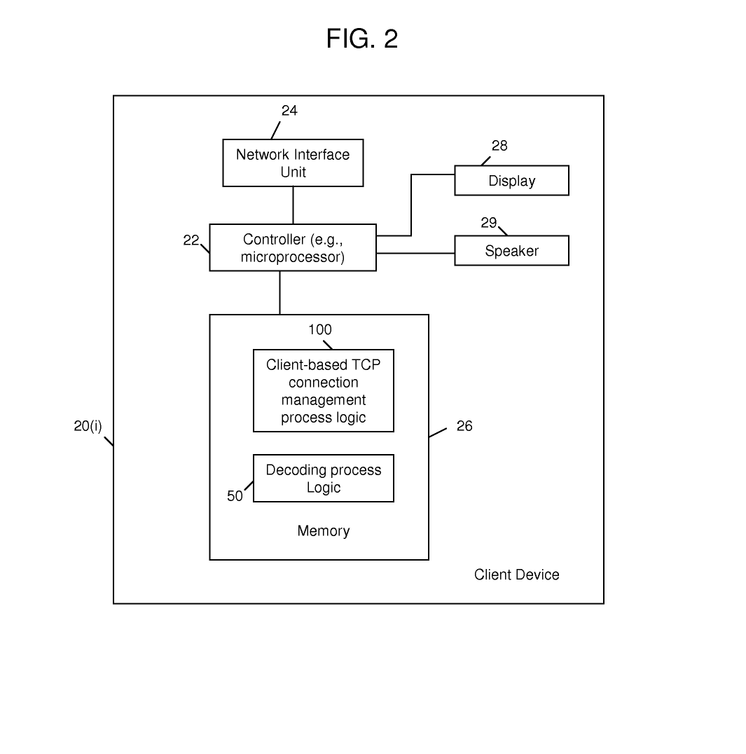

Reference is made to FIG. 2 for an example of a block diagram of a client device that is configured to perform the client-based TCP connection management control techniques described herein. FIG. 2 illustrates a block diagram of a generic client device at reference numeral 20(i) (and representative of any of the client devices 20(1)-20(N) shown in FIG. 1) and is meant to show only those components of a client device that are related to the client device operations described herein.

The client device 20(i) comprises a controller 22, a network interface unit 24, a memory 26, a display 28 and audio speaker 29. The controller 22 is a data processing device, e.g., a microprocessor, microcontroller, systems on a chip (SOCs) processing device, or other fixed or programmable logic. The controller 22 interfaces with the memory 26 that may be any form of random access memory (RAM) or read only memory (ROM) or other data storage block that stores data and instructions used for the techniques described herein. The memory 26 may be separate or part of the controller 22.

The functions of the controller 22 may be implemented by a processor or computer readable tangible (non-transitory) memory medium encoded with instructions or by logic encoded in one or more tangible media (e.g., embedded logic such as an application specific integrated circuit (ASIC), digital signal processor (DSP) instructions, software that is executed by a processor, etc.), wherein the memory 26 stores data used for the computations or functions described herein (and/or stores software or processor instructions that are executed to carry out the computations or functions described herein).

The network interface unit 24 enables network communications over a network and may comprise wired network communications capability as afforded by an Ethernet interface unit and/or wireless network communications capability as provided by a WiFi™ interface unit, or even wireless WAN communication capability. The display 28 may be a liquid crystal display (LCD) or other display device configured to display video images (frames) that are produced from decoding of received digital packets. Similarly, the audio speaker 29 is a speaker device capable of outputting audio that results from decoding of received digital packets and conversion to analog audio signals by a suitable sound card unit that may be part of the controller, part of the speaker 29 or a separate component.

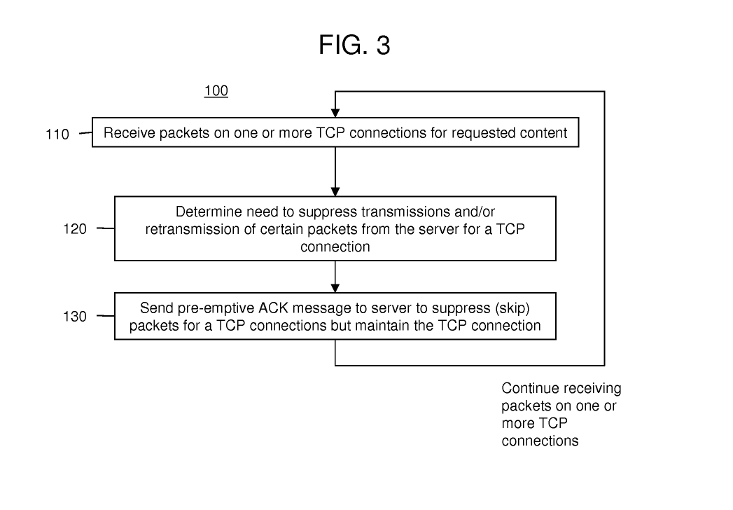

The decoding process logic 50 comprises instructions that, when executed by the controller 22, cause the controller to decode the received encoded packets from streamed digital media content to produce video frames for display and audio output on the display 28 and speaker 29. The client-based TCP connection management process logic 100 comprises instructions that, when executed by the controller 22, cause the controller 22 to perform the operations described herein in connection with FIGS. 3-8. Again, the process logic 100 may be implemented with fixed logic or programmable logic (e.g., software/computer instructions executed by a processor or field programmable gate array (FPGA)), or the processor or computer readable tangible medium may be encoded with instructions that, when executed by a processor, cause the processor to execute the process logic 100.

The descriptions made herein refer to TCP as an example of a protocol for which the techniques may be useful. This is meant by way of example only. These techniques may be used with any suitable protocol now known or hereinafter developed that uses acknowledgment (ACK) messages or packets before sending new information. Moreover, in TCP, each unit of data is referred to as a “byte” and is assigned a number called a byte number for purposes of allowing the sender to track whether the receiver has received using ACK messages. In TCP, a client device sends an ACK message for a “byte” number. For example, the following describes the use of a pre-emptive ACK message that is sent with respect to bytes up to a designated byte number. Other protocols may use the term “packet” instead of “byte” and track a packet with a “packet number”. Functionality, “packet” and “byte” are similar as our “packet number” and “byte number”. The term “packet” is meant to be inclusive of the term “byte” and refer to any kind of data unit.

Reference is now made to FIGS. 3-5 for a description of a first aspect of the process logic 100 that involves using a pre-emptive ACK message by the client device. At 110, the client device receives packets (e.g., bytes) for streaming content on one or more TCP connections from the streaming server. At 120, the client device determines the need to suppress transmission (and/or retransmission) of certain (one or more) bytes from the streaming server on the TCP connection. There are several reasons why the client device may be configured to suppress bytes from the streaming server, examples of which are described herein. At 130, the client device sends a pre-emptive ACK message to the streaming server with information in the message configured to cause the streaming server to suppress (skip) the transmission of one or more bytes on the TCP connection but to otherwise maintain that TCP connection. In other words, the pre-emptive ACK message is a message that is configured to cause the streaming server not to transmit one or more bytes to the client device for the connection but without terminating the connection.

At the client device, changes are made to the streaming functionality by way of the process logic 100 to emulate TCP by using raw sockets in the transport layer. A TCP socket is defined as an endpoint for communication, and consists of the pair <IP Address, Port>. The process logic 100 has control over the raw TCP sockets and can manage them according to conventional TCP rules as well to perform the pre-emptive ACK messaging techniques of FIGS. 3-5. In another variation, there are user-mode TCP implementations that may be used to avoid having to integrate a modified TCP stack with the user application in the client device.

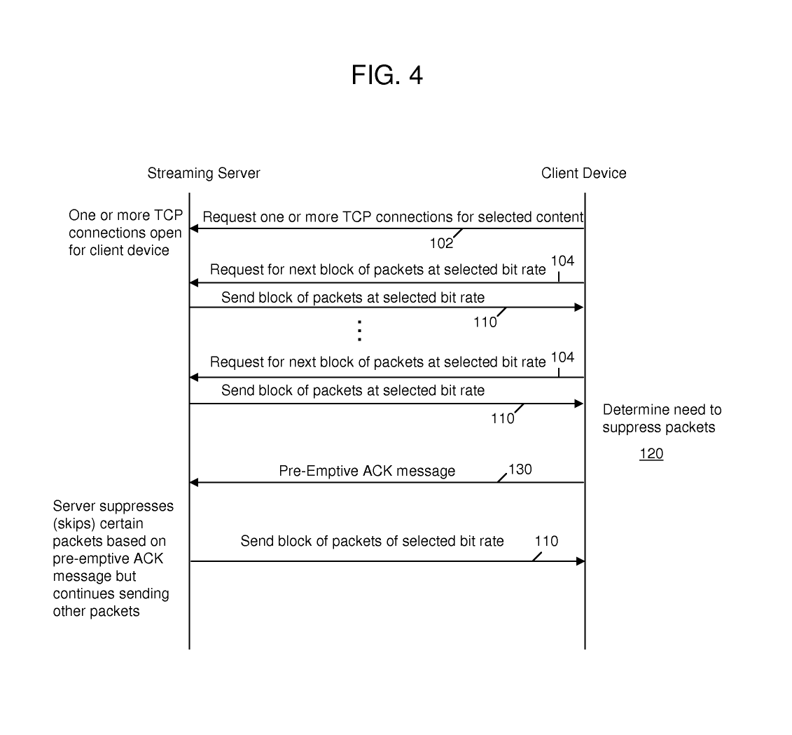

As shown in FIG. 4, the client device sends a message to the streaming server at 102 to request one or more TCP connections for selected content. The streaming server opens the one or more connections in response to the request. Thereafter, the client device sends a request message to the streaming server for a block of packets (e.g., bytes) as shown at 104 and receives the block of packets at 110. This process continues, under control of the requests made at the client device, in order to keep up with the decoding operations at the client device. At some point, the client device determines the need to suppress one or more bytes at 120 and sends a pre-emptive ACK message with the appropriate information (sequence number) to cause the streaming server to suppress (not send) one or more packets to the client device, and instead the streaming server sends a block of bytes (beginning in sequence after the packets that were suppressed) at a selected bit rate. The client device, at 110, receives the bytes at the selected bit rate, after the pre-emptive ACK message was sent. The selected bit rate after the pre-emptive ACK message was sent may be the same as or different from the bit rate of the stream on that TCP connection that the client device was receiving prior to sending the pre-emptive ACK message.

There are several reasons why the client device may send the pre-emptive ACK message. Regardless of the underlying reason, the pre-emptive ACK serves to avoid any retransmissions that may be in process and/or transmissions of new bytes by the streaming server, thus preventing any timeouts at the streaming server.

A client device receiving a TCP stream may become not interested in what is about to be delivered to it in an existing TCP connection for a variety of reasons. In adaptive streaming, one reason may be that the bytes which were requested earlier by the client are not needed any longer. In one scenario, the client device is receiving a higher-quality (higher bit rate and/or resolution) version of the same block of bytes on a different bit rate profile and therefore does not need the bytes received on an earlier requested bit rate profile. In another scenario, the client device knows that the bytes that need to be retransmitted will not arrive in time for a decoding process deadline (given the current presentation position in the digital content) since there is an imminent congestion, e.g., learned via an Explicit Congestion Notification (ECN) message and/or through observation, and the client device decides to obtain a lower-quality version of the block on a different bit rate profile than the one the client device is currently using. In this case, the client device determines not to request retransmission by the streaming server of one or more bytes that have not yet been successfully received by the client device (by way of the pre-emptive ACK message) so that the streaming server does not retransmit the bytes (for the high-quality bit rate block). In still another scenario, the retransmissions could arrive too late or not be needed any longer so the client device may send a pre-emptive ACK to cause the server not to send them. In yet another scenario, the client device may jump to a different segment of a streaming video program and therefore the bytes that were otherwise in queue to be next sent to the client device are not needed since the client device is going to request bytes for an entirely different segment of the program content or for different program content.

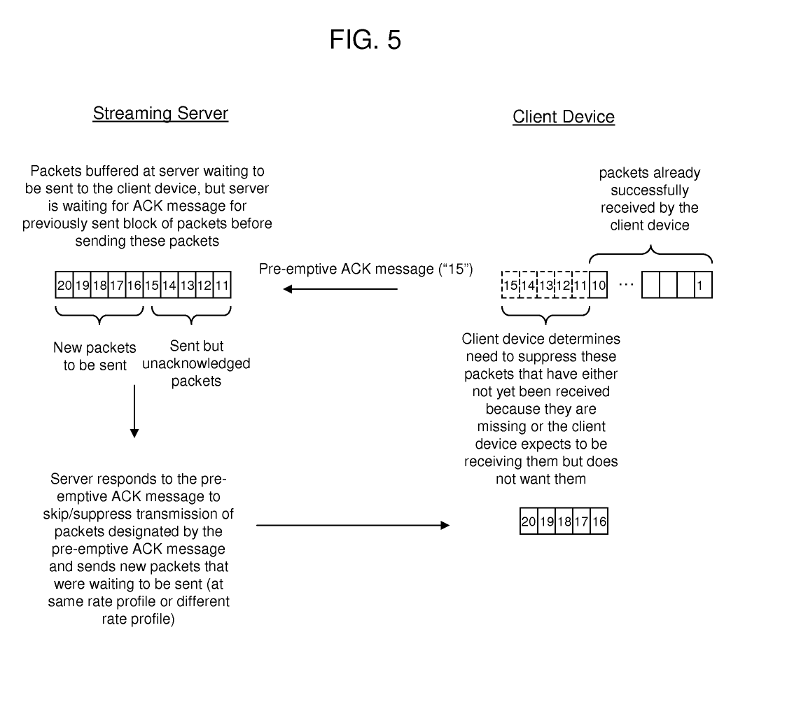

Reference is now made to FIG. 5 that shows one example of the pre-emptive ACK message operation. FIG. 5 shows that the client device has already successfully received bytes #1-10 for a given TCP connection. However, the client device determines that it does not need or want bytes #11-15, shown in dotted lines. The client device may determine the need to suppress bytes #11-15 that have not yet been received because they are missing (and therefore not ACK'd yet) or the client device simply determines that it does not want them even though they are to be transmitted next. The streaming server has a buffer containing bytes #11-15 because it is waiting for an ACK message for bytes #11-15 and the buffer also contains new bytes 16-20 queued up for transmission.

In TCP there is no possibility or configuration to make the server skip certain bytes which have not yet been ACK'd. The sender (streaming server) stops transmitting a byte only after its receipt is ACK'd by the client device. ACK messages in TCP are cumulative in byte range. In simple terms, if the client device sends an ACK message with information indicating an ACK to byte #5, this means the client device has received all the bytes before and including byte #5.

Thus, in the example shown in FIG. 5, the client device sends a pre-emptive ACK message with information indicating an ACK to byte #15. This will cause the server to skip or suppress the transmission of bytes #11-15 and to send new bytes starting from #16 to the client device. Bytes #16-20 may be bytes at the same bit rate profile as bytes #1-10 received by the client device or a different bit rate profile (faster or slower). For example, the client device may send the pre-emptive ACK message for bytes #11-15 to cause the streaming server to stop sending bytes at a first relatively higher bit rate profile and, at the same time, or in a request message immediately thereafter, request the streaming server to send bytes #16-20 (or even packets #11-15) at a second relatively lower bit rate profile, perhaps with a larger window size to avoid “slow start” issues. This may be desirable during a period of time where the client device is experiencing poor performance, such as can be the case on a wireless link, but sometime later performance may improve on that wireless link and the client device can request for a block of bytes at a higher bit rate profile. By causing the streaming server not to send certain bytes, the available bandwidth in the core and/or access networks is better utilized, ultimately improving the overall streaming experience. Thus, the pre-emptive ACK message comprises information indicating that one or more bytes up to a designated packet (e.g., byte) number have been received by the client device when in fact the one or more packets (e.g., bytes) have not been received by the client device because the client device has determined that it does not want the one or more packets (e.g., bytes).

The only other option for the client device to suppress the transmission is to reset or terminate that TCP connection and restart at new TCP connection. Restarting a TCP connection has many disadvantages, not the least of which is the time required to start a new TCP connection, which can be disruptive in the middle of a streaming media session.

The ability for the client device to cause the streaming server to suppress packet transmissions (or retransmissions) is particularly useful for TCP connections experiencing long delays as can be the case for streaming over a wireless link. In addition, a client device can send a pre-emptive ACK message to cause the server to skip undesired bytes in response to an ECN message. No special capabilities or configurations are needed at the streaming server to perform the techniques described herein in connection with FIGS. 3-5.

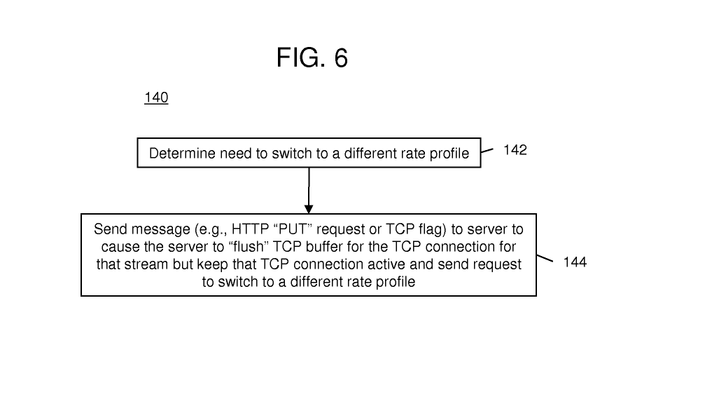

Turning now to FIGS. 6-8, an additional operation of the client-based TCP connection management process logic 100 is shown at 140. The operation depicted in FIGS. 6-8 may be used in addition to or independent of the pre-emptive ACK operation described above in connection with FIGS. 3-5. In order to maintain the TCP connection state for an active TCP connection, as the client determines that there is a case of HOL blocking, and wishes to switch to a different bit rate, the client device sends a further message to the streaming server that is configured to cause the server to “flush” all of its existing TCP buffers that are queued for transmission, but not yet transmitted.

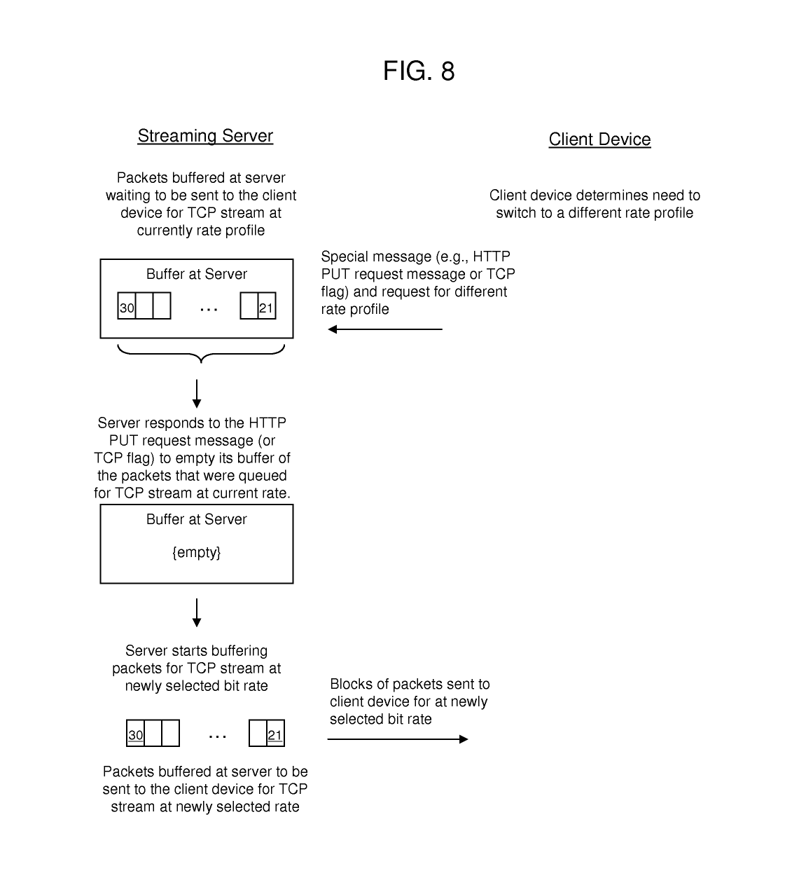

Thus, as shown in FIG. 8, at 142 the client device determines the need to switch to a different rate profile. The client may make this determination by detecting delays in transmissions of new bytes from the streaming server, which in turn may be caused by errors in received bytes and thus the need for retransmissions of bytes, or by receiving an ECN. In any case, at 144, the client device sends a message that is configured to case the streaming server to flush or empty the contents of its TCP buffer for the TCP connection at that bit rate (but to keep that TCP connection active) and sends a request to switch to a different rate profile. For example, the message sent at 144 may be an HTTP PUT request to the server or a TCP flag/option that the streaming server is configured to recognize and respond to by flushing its TCP buffer for the TCP connection. Thus, the streaming server is configured, by a software modification for example, to recognize the special message, whether it is an HTTP PUT request, TCP flag or other message, and to respond by flushing the TCP buffer for that TCP connection but not to terminate the TCP connection.

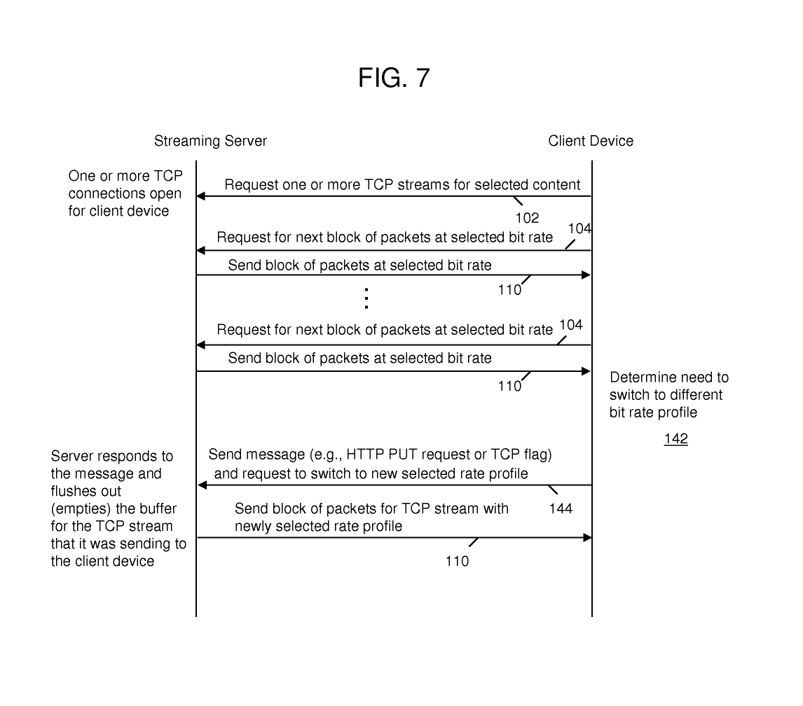

With reference to FIG. 7, the client device requests blocks of packets (e.g., bytes) at a selected bit rate (first bit rate) as shown at 104 and receives the blocks of bytes from the streaming server at 110. At 142, the client device determines the need to switch to a different bit rate profile (second bit rate). At 144, the client device sends the message (e.g., HTTP PUT request, TCP flag, etc.) and the request to switch to the new selected bit rate (second bit rate) profile. The server recognizes and responds to the message and flushes its buffer for the TCP connection at the current bit rate profile and as shown thereafter at 110, the client device receives bytes from the server at the newly selected bit rate profile.

FIG. 8 shows this operation 140 from still another perspective. In this example, the streaming server has a buffer that contains bytes #21-30. When the client determines the need to switch to a different rate profile, it sends the message (HTTP PUT request, TCP flag, etc.) and the request for a different rate profile. The server recognizes the message and responds by emptying the buffer of bytes #21-30 that were queued for transmission at the current bit rate profile. Then, the server starts buffering packets at the newly selected bit rate, e.g., bytes #21-30, where the underline designation indicates these bytes are at the newly selected bit rate.

The technique described herein in connection with FIGS. 6-8 alone or combined with the pre-emptive ACK message operation described above in connection with FIGS. 3-5 reduces any overhead of bytes that are queued up for transmission, while maintaining the TCP state so that the streaming server does not have to perform a slow-start for a new TCP connection.

The use of pre-emptive ACK messages (FIGS. 3-5) and TCP buffer flushing (FIGS. 6-8) for one or more TCP connections reduces overhead in the network and at the client device, and reduces the number of TCP connections required. The techniques described herein minimize the number of HTTP/TCP connections required for adaptive streaming, as compared to any existing solution, and address the HOL blocking problem. These techniques reduce any network overhead caused by retransmission of packets. The overall streaming experience is improved by keeping the TCP connections alive or active, and not forcing new connections which can be slow to start and negatively impact performance of a streaming media session.

The above description is intended by way of example only.

What is claimed is:

1. A method comprising:
at a client device that is receiving streaming content on a connection from a streaming server over a network, determining a need to suppress transmission of one or more packets from the streaming server on the connection with the streaming server; and
sending from the client device to the streaming server a message configured to cause the streaming server not to transmit the one or more packets to the client device for the connection without terminating the connection.

2. The method of claim 1, wherein sending the message comprises sending an acknowledgment message comprising information indicating that packets up to a designated packet number have been received by the client device when in fact the one or more packets have not been received by the client device.

3. The method of claim 1, and further comprising determining at the client device to switch from a first bit rate to a second bit rate and sending a request to the streaming server for packets at the second bit rate.

4. The method of claim 1, and further comprising sending from the client device to the streaming server a further message configured to cause the streaming server to empty a buffer of packets that are queued for transmission but have not yet been transmitted at a first bit rate to the client device.

5. The method of claim 4, and further comprising sending a request to select a second bit rate for transmission of packets on the connection.

6. The method of claim 4, wherein sending the further message comprises sending an Hypertext Transfer Protocol (HTTP) PUT message that is configured to be recognized by the streaming server and to cause the streaming server to empty the buffer.

7. The method of claim 4, wherein sending the further message comprises sending a Transmission Control Protocol (TCP) flag that is configured to be recognized by the streaming server and to cause the streaming server to empty the buffer.

8. The method of claim 1, wherein determining comprises determining not to request retransmission by the streaming server of the one or more packets that have not yet been successfully received by the client device.

9. The method of claim 1, wherein determining comprises determining that a segment of the content containing the one or more packets is not needed because the client device is going to request packets for an entirely different segment of the content or for different content.

10. An apparatus comprising:
a network interface unit configured to enable communications over a network;
a controller configured to be coupled to the network interface unit, the controller configured to:
determine a need to suppress transmission of one or more packets from a streaming server for a connection with a streaming server over the network; and
generate a message to be sent to the streaming server, wherein the message is configured to cause the streaming server not to transmit the one or more packets for the connection without terminating the connection.

11. The apparatus of claim 10, wherein the controller is configured to generate the message that comprises an acknowledgment message comprising information indicating that packets up to a designated packet number have been received when in fact the one or more packets have not been received.

12. The apparatus of claim 10, wherein the controller is configured to generate a further message to be sent to the streaming server, the further message configured to cause the streaming server to empty a buffer of packets that are queued for transmission but have not yet been transmitted at a first bit rate.

13. The apparatus of claim 12, wherein the controller is further configured to send to the streaming server a request to select a second bit rate for transmission of packets by the streaming server on the connection.

14. The apparatus of claim 10, wherein the controller is configured to determine not to request transmission by the streaming server of the one or more packets that have not yet been successfully received.

15. The apparatus of claim 10, wherein the controller is configured to determine that a segment of the content containing the one or more packets is not needed because packets are to be requested for an entirely different segment or different content.

16. A computer readable medium storing instructions that, when executed by a processor, cause the processor to:
determine a need to suppress transmission of one or more packets from a streaming server to the client device for a connection with the streaming server; and
generate a message to be sent to the streaming server, wherein the message is configured to cause the streaming server not to transmit the one or more packets to the client device for the connection without terminating the connection.

17. The computer readable medium of claim 16, wherein the instructions that, when executed by the processor, cause the processor to generate the message comprise instructions that cause the processor generate an acknowledgment message comprising information indicating that packets up to a designated packet number have been received by the client device when in fact the one or more packets have not been received by the client device.

18. The computer readable medium of claim 16, and further comprising instructions that, when executed by the processor, cause the processor to generate a further message to be sent to the streaming server, the further message configured to cause the streaming server to empty a buffer of packets that are queued for transmission but have not yet been transmitted at a first bit rate to the client device.

19. The computer readable medium of claim 18, and further comprising instructions that, when executed by the processor, cause the processor to generate a request to select a second bit rate for transmission of packets by the streaming server on the connection.

20. The computer readable medium of claim 16, wherein the instructions that, when executed by the processor, cause the processor to determine comprise instructions that cause the processor to determine that a segment of the content containing the one or more packets is not needed because the client device is going to request packets for an entirely different segment of the content or for a different content.
